(19) United States
(12) Patent Application Publication
(10) Pub. No.: US 2004/0084905 A1
(43) Pub. Date: May 6, 2004

(54) Solar driven turbine loop

(76) Inventor: Lennart Strand, Angelholm (SE)

Correspondence Address: MCGINN & GIBB, PLLC, 8321 OLD COURTHOUSE ROAD, SUITE 200, VIENNA, VA, 22182-3817, US

(21) Appl. No.: 10/250,331

(22) PCT Filed: Dec. 25, 2001
(86) PCT No.: PCT/SE01/02890

(30) Foreign Application Priority Data
Dec. 29, 2000 (SE) 0004930-4

(51) Int. Cl. B60L 1/02

(52) U.S. Cl. 290/2

(57) ABSTRACT

A solar driven turbine loop for electricity production and cooling can advantageously be erected in sunny countries. Solar cells (1) with circulating water are heated up to 120°-160° C. (2). Pumped (3) via the superheater (4) f a medium turbine loop to a medium vaporiser (19) and then in return for reheating. A second branch (27) of the hot water is led to accumulators (30-31) for night operations. Superheated medium vapour is forced through a liquid separator (5) to the medium turbine (7) at high pressure and with high energy content. The turbine drives an electric generator (8), possibly also a heating pump compressor (10). If only the electricity generator is driven, an electrically driven heating pump is installed. The medium vapour expands to a lower pressure and the medium energy content in the turbine and condenses in subsequent condenser (13). This with the aid of cool circulating water (38) which was cooled in an air cooled condenser (37). Condensed medium goes via a pressurising pump (16) through preheater (12) to vaporiser (19). Another branch (31) condensed medium passes an expansion valve (22) to a coolant battery (24). The medium now in vapour form (25) is sucked to the heating pump compressor (10). Forced thereafter (26) together with saturated medium vapour (20) to the superheater (4).

The present invention is intended principally to be installed in sunny countries with a large need for air conditioned premises and which moreover have a high electricity tariff.

The present invention is suitable for, for example, detached houses, properties, offices, commercial centres, hospitals as well as hotel installations etc.

The present invention consists of two loops, of which the one has water as the circulating medium which is heated up in solar cells and emits thermal energy to the medium of the second loop in a superheater. This loop consists of a steam turbine and an electric generator which delivers drive energy to the electric motor of a heating pump. Alternatively, the turbine is provided with a through shaft of which the one end drives, via a gearbox, the coolant compressor and the other drives the electric generator. After the turbine, the medium is condensed and converts into liquid form in order they to be led into the coolant section of the heating pump and supply thermal energy. The compressor of the heating pump pumps the medium to the superheater where the solar heated water supplies the medium with additional thermal energy. The now superheated medium thereafter drives the steam turbine.

The circulating medium has a low boiling point and is not toxic or harmful to the environment.

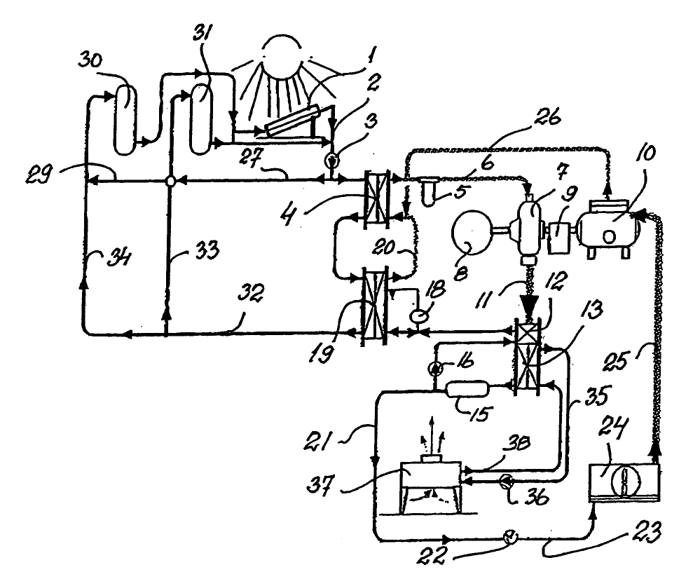

### THE INVENTION FUNCTIONS IN ACCORDANCE WITH THE DIAGRAM IN FIG. 1

The water is heated in a solar cell 1 to a temperature of approx. 120°-160° C. 2. The hot water is circulated by a pump 3 to a superheater 4 and supplies the circulating medium in the turbine loop with thermal energy. The circulating hot water passes after the superheater into a medium vaporiser 19 where the medium in the loop is converted from liquid phase into vapour 20.

Thereafter, the vapour is led into the superheater 4 to be supplied with additional thermal energy, the departing steam passes a liquid separator 5 and at high pressure and also large thermal content to the medium steam turbine 7.

In this, thermal energy is converted into kinetic energy which drives an electric generator 8 for electricity production. If the turbine has a through shaft, it also drives, via a gearbox 9, the compressor 10 of a heating pump. The departing expanded vapour 11 from the turbine at lower pressure and thermal energy passes a preheater 12 with a liquiform coolant and thereafter enters into the condenser 13. The medium vapour condenses there, in other words converts into liquid form by cooling by the circulating water.

The departing water from the condenser 35 is pumped by a pump 36 into an air cooled condenser 37 for cooling and at lower temperature 38 back to the turbine condenser. The condensed medium in liquid form 14 after the condenser is led into liquid tank 15 where the total content of medium is to be accommodated. the circulating met in the turbine loop must have a low boiling point be non-toxic and non-inflammable and not affect the ozone layer. After the tank, a partial current 21 goes to the coolant/heating pump system. The second branch is pumped with a pressuriser pump 16 to the turbine loop. After the pump the medium is preheated in the preheater 12. With elevated energy content and still in liquid form 17 through a level valve 18 which ensures the maintenance of a count level in the subsequent vaporiser 19. The cycle of the loop is now completed. The second branch after the liquid tank 21 of the loop is provided with a throttle, so-called expander valve 22. Its purpose is to cause the medium to expand from higher to lower pressure 23. The medium strives to recover the beat lost on the expansion. This takes place e.g. in coolant fan batteries 24. This takes place with warmer circulating premises air and the medium converts to vapour form 25 in order thereafter to be sucked into the compressor 10. In this, friction and compression heat are supplied and with a high thermal energy content approx. 3-3.5 times supplied drive energy to the compressor, the medium vapour 26 is forced to the superheater 4 where it is superheated together with the circulating medium in the loop.

After the hot water pump 3, the conduit branches of which the one as was previously mentioned goes to the superheater. In the other branch, a part current is led via conduit 27 for filling an accumulator either 30 or 31. This takes place with the conduits 28, 29. The conduits 32, 33, 34 lead water from the vaporiser 19 to the accumulator tanks.

The solar cells 1 are made of flanged pipe loops, encapsulated in hermetically closed packages which are insulated and provided with a glazed cover for the solar radiation. The number of packages is determined by the required surface. The solar cells are placed for maximum solar radiation.

Circulation pump 3 conveys heated water from the solar cells in daytime and through a bypass connection during the night time from water accumulator, On the pressure side of the pump a part current leads to one or more accumulators in order to be used after sunset. The other part current is led into the superheater where the hot water emits heat to the medium which is circulating in the turbine loop. After the superheater it enters into the vaporiser and back via accumulator to the solar cell.

The medium steam turbine 7 is driven with superheated medium vapour and outgoing steam is led to a water cooled condenser.

The turbine condenser 13 is a hermetically closed plate cooler in which the medium vapour condenses and conveys into liquid form on cooling.

The coolant water pump for inward transport of coolant water to the condenser, the water may consist either of seawater or groundwater as well as circulating water between the turbine condenser and an air cooled condenser.

The medium tank accommodating the contents of the entire loop is provided with a level gauge and safety valve.

An expansion valve 22 functions as a throttle device and the medium liquid expands from a higher to a lower pressure and is placed inside the coolant unit.

The coolant unit 24 where thee medium strives for heat for lost thermal energy on expansion. E.g. a fan transports local air through a coolant battery ad is delivered at lower temperature. The medium is vaporised and converts from liquid to vapour.

The heating pump compressor is driven by an electric motor or alternatively by the medium turbine via a gearbox.

### List Reference Numerals on the Drawing

1 Solar cell

2 conduit with water 120°-160° C.

3 circulation pump

4 superheater

5 liquid separator

6 conduit for stream

7 medium turbine

8 generator

9 gearbox

10 heating pump compressor

11 conduit for expanded low pressure vapour

12 preheater

13 condenser

14 conduit for medium condensed into liquid

15 liquid tank

16 pressuriser pump

17 conduit for liquid

18 level gauge

19 vaporiser

20 conduit for saturated medium vapour

21 conduit after liquid tank

22 xpansion valve

23 conduit for medium expanded to lower pressure

24 coolant and fan battery

25 conduit for medium converted into vapour from

27 conduit for water from solar cell to accumulator tanks

28 conduit to accumulator 31

29 conduit to accumulator 30

30 accumulator tank

31 accumulator tank

32 conduit to accumulator 30, 31

33 conduit to accumulator 30, 31

34 conduit to accumulator 30, 31

1. Solar driven turbine loop for electricity production and cooling, characterised in that in sunny countries installing solar cells (1) with a circulating water which is heated up to approx. 120°-160° C. (2), the hot water emitting heat to a medium which has a low boiling point in the vaporiser (19) of a turbine loop and a superheater (4), the turbine (7) driving an electric generator (8) for electricity production of which a part drives an electrically powered heating pump for cooling and heating, alternatively the turbine also drives, via a gearbox (9), the compressor (10) of a heating pump and both the heating pump and turbine loop having the same circulating medium.

2. The method as claimed in claim 1, characterised in that the 3-3.5 times higher energy content against supplied driving energy is forced the medium (26) after the heating pump compressor (10) together with the medium vapour (20) of the turbine loop into the superheater (4) of the loop, in order to supply additional thermal energy to the medium vapour.

3. The method as claimed in claims 1 and 2, characterised in that if the turbine (7) only drives an electric generator (8) this supplies electric current to a motor driven heating pump compressor (10).

4. The method as claimed in claims 1, 2 and 3, characterised in that the turbine condenser (13) is cooled with the circulating water (38) which has been cooled in an air cooled condenser (37).

5. The method as claimed in claims 1 and 2, characterised in that accumulators (30-31) are filled during hours of sunshine accumulators with hot water in order to be able to drive the turbine loop at night a well.

6. The method as claimed in claim 1, 2 and 3, characterised in that most of the equipment of the turbine loop is mounted in a container-like building and thereafter the equipment need not be assembled an site.
